(19) United States
(12) Patent Application Publication
(10) Pub. No.: US 2009/0307468 A1
(43) Pub. Date: Dec. 10, 2009

(54) Generating a Test Case Micro Generator During Processor Design Verification and Validation

(75) Inventors: Shubhodeep Roy Choudhury, Bangalore (IN); Manoj Dusanapudi, Bangalore (IN); Sunil Suresh Hatti, Gokul (IN); Shakti Kapoor, Austin, TX (US); Rahul Sharad Moharil, Nagpur (IN)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 12/134,255

(22) Filed: Jun. 6, 2008

(51) Int. Cl. G06F 9/22

(52) U.S. Cl. 712/227; 712/E09.006

(57) ABSTRACT

A main generator generates a micro generator and initial test cases based upon a processor architecture specifications and user input, such as general purpose register availability, translation information, instruction sequences, base register available, target real memory pages, etc. In turn, the micro generator tests a processor using the initial test cases and subsequent test cases generated by the micro generator. The subsequent test cases may include modified test case properties such as changed machine state register bits, changed instruction sequence (shuffling), changed effective segment ID bits, and/or changed virtual segment ID bits. In addition to generating subsequent test cases, the micro generator performs functions such as test case dispatching, test case scheduling, test case execution, and interrupt handling.

### BACKGROUND OF THE INVENTION

1. Technical Field

The present invention relates to using a main generator to produce a micro generator that generates and executes test patterns during processor design verification and validation.

2. Description of the Related Art

Processor testing tools exist whose goal is to generate the most stressful test case for a processor. In theory, the generated test case should provide maximum test coverage and should be interesting enough to stress various timing scenarios on the processor. The whole technology of these tools sits in the logic of building and executing these test cases. Verifying and validating a processor using test cases typically includes three stages, which are 1) a test case build stage, 2) a test case execution stage, and 3) a validation and verification stage. Besides the test cases themselves, another important aspect of processor testing is a generator that generates and executes the test cases.

### SUMMARY

A main generator selects instructions, which are based upon a processor resource specification, and generates a micro generator from the selected instructions. In turn, the micro generator is adapted to execute a test case that tests a processor that corresponds to the processor resource specification.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a main generator generating a micro generator and test cases based upon processor architecture specifications and resource pools;

FIG. 4 is a diagram showing a micro generator generating and executing test cases;

FIG. 5 is a high level flowchart showing steps taken in generating a micro generator and generating test cases;

FIG. 6 is a flowchart showing steps taken in generating a micro generator;

FIG. 7 is a flowchart showing steps taken in generating test cases;

FIG. 8 is a flowchart showing steps taken in testing a processor using a micro generator; and

FIG. 9 is a flowchart showing steps taken in shuffling a test case that comprises sub test cases.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

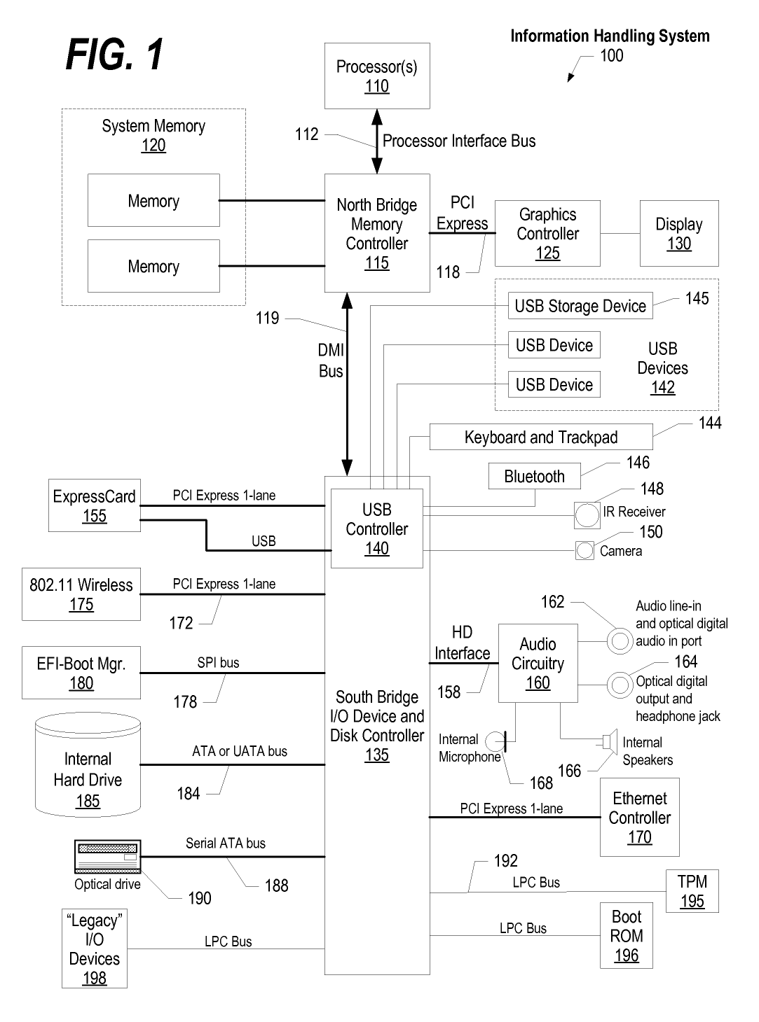

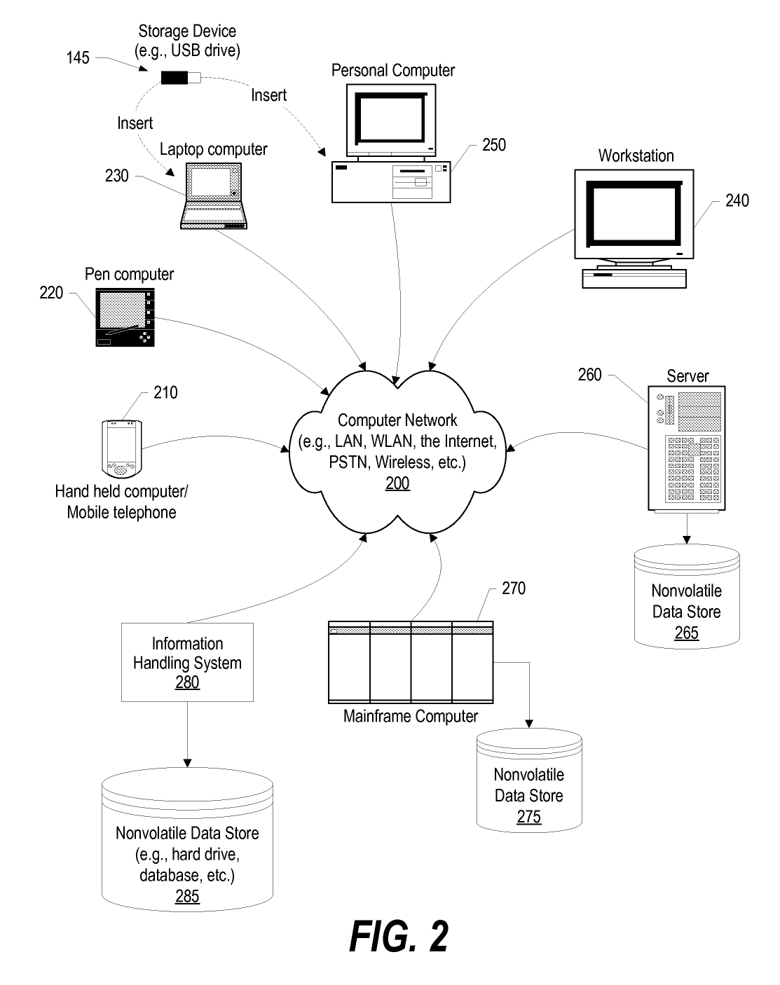

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100 which is a simplified example of a computer system capable of performing the computing operations described herein. Information handling system 100 includes one or more processors 110 which is coupled to processor interface bus 112. Processor interface bus 112 connects processors 110 to Northbridge 115, which is also known as the Memory Controller Hub (MCH). Northbridge 115 is connected to system memory 120 and provides a means for processor(s) 110 to access the system memory. Graphics controller 125 is also connected to Northbridge 115. In one embodiment, PCI Express bus 118 is used to connect Northbridge 115 to graphics controller 125. Graphics controller 125 is connected to display device 130, such as a computer monitor.

Northbridge 115 and Southbridge 135 are connected to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus is used to connect the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses can include PCI and PCI Express busses, an ISA bus, a System Management Bus (SMBus or SMB), a Low Pin Count (LPC) bus. The LPC bus is often used to connect low-bandwidth devices, such as boot ROM 196 and “legacy” I/O devices (using a “super I/O” chip). The “legacy” I/O devices (198) can include serial and parallel ports, keyboard, mouse, floppy disk controller. The LPC bus is also used to connect Southbridge 135 to Trusted Platform Module (TPM) 195. Other components often included in Southbridge 135 include a Direct Memory Access (DMA) controller, a Programmable Interrupt Controller (PIC), a storage device controller, which connects Southbridge 135 to nonvolatile storage device 185, such as a hard disk drive, using bus 184.

ExpressCard 155 is a slot used to connect hot-pluggable devices to the information handling system. ExpressCard 155 supports both PCI Express and USB connectivity as it is connected to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, Bluetooth device 146 which provides for wireless personal area networks (PANs), keyboard and trackpad 144, and other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etc.

Wireless Local Area Network (LAN) device 175 is connected to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 is connected to Southbridge 135 using Serial ATA (SATA) bus 188. Serial ATA adapters and devices communicate over a high-speed serial link. The Serial ATA bus is also used to connect Southbridge 135 to other forms of storage devices, such as hard disk drives. Audio circuitry 160, such as a sound card, is connected to Southbridge 135 via bus 158. Audio circuitry 160 is used to provide functionality such as audio line-in and optical digital audio in port 162, optical digital output and headphone jack 164, internal speakers 166, and internal microphone 168. Ethernet controller 170 is connected to Southbridge 135 using a bus, such as the PCI or PCI Express bus. Ethernet controller 170 is used to connect information handling system 100 with a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems which operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling system include nonvolatile data stores, such as hard drives and/or nonvolatile memory. Some of the information handling systems shown in FIG. 2 are depicted with separate nonvolatile data stores (server 260 is shown with nonvolatile data store 265, mainframe computer 270 is shown with nonvolatile data store 275, and information handling system 280 is shown with nonvolatile data store 285). The nonvolatile data store can be a component that is external to the various information handling systems or can be internal to one of the information handling systems. In addition, removable nonvolatile storage device 145 can be shared amongst two or more information handling systems using various techniques, such as connecting the removable nonvolatile storage device 145 to a USB port or other connector of the information handling systems.

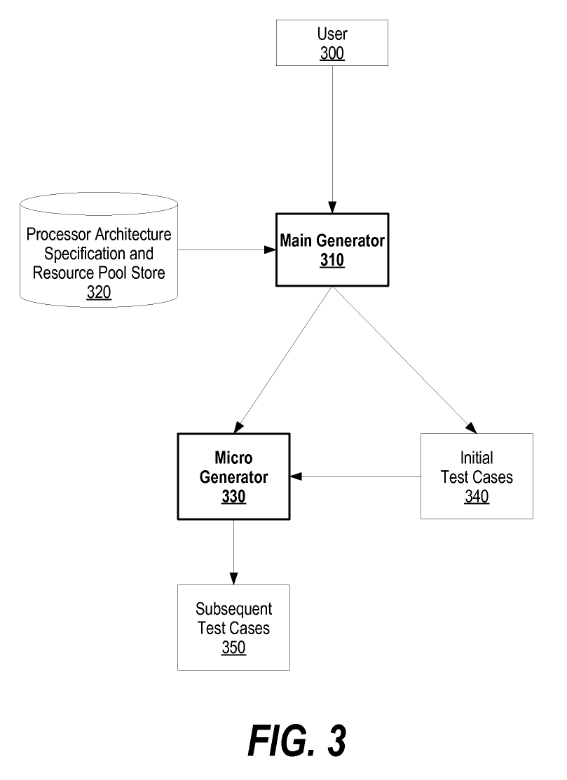

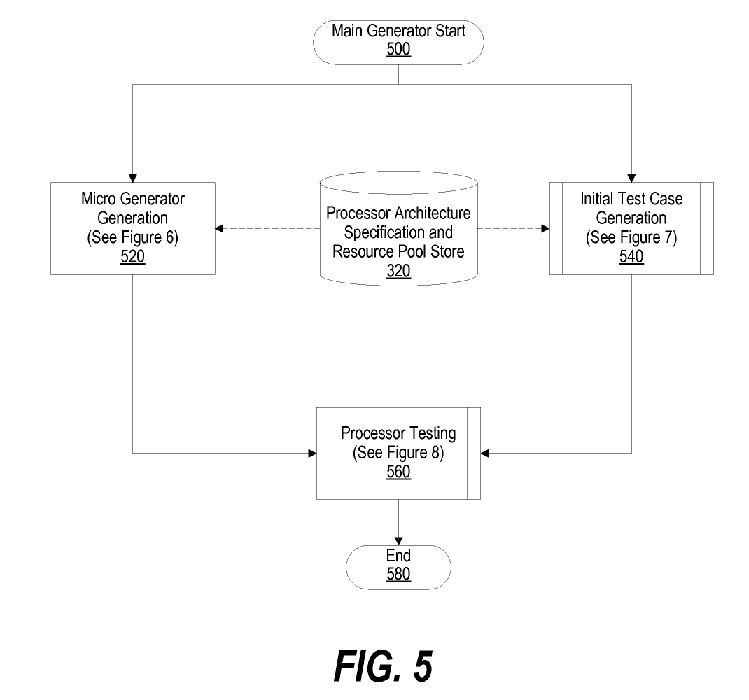

FIG. 3 a diagram showing a main generator generating a micro generator and test cases based upon processor architecture specifications and user input. Main generator 310 receives processor resource availability input from user 300, such as general purpose registers, translation information, instruction sequences, base registers, target real memory pages, etc. Main generator 310 analyzes the user input and generates micro generator 330 and initial test cases 340 based upon a processor architecture specification included in processor architecture specification and resource pool 320 (see FIGS. 5-7 and corresponding text for further details).

In turn, micro generator 330 performs functions such as generating subsequent test cases 350 from initial test cases 340, test case dispatching, test case scheduling, test case execution, and interrupt handling. When generating subsequent test cases, micro generator 330 may modify test case properties such as changing machine state register bits, changing the instruction sequence (shuffling), changing ESID and VSID bits (Effective Segment ID bits and Virtual Segment ID bits), etc.

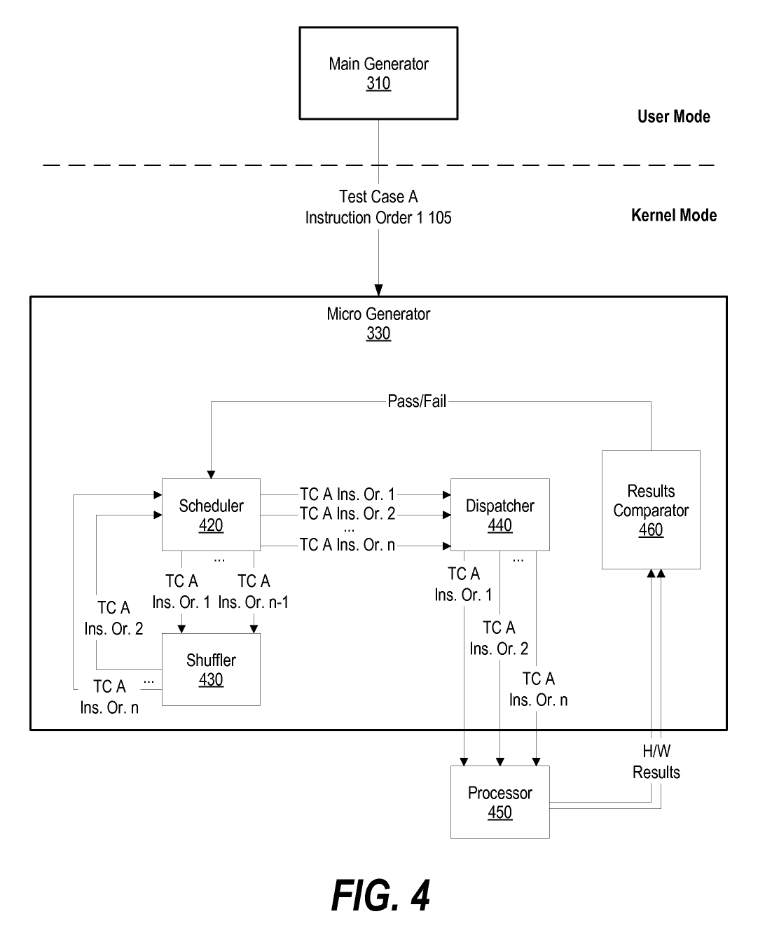

FIG. 4 is a diagram showing a micro generator generating and executing test cases. Main generator 310 operates in a user mode and generates test case A 105 for use in testing processor 450. The test case includes a plurality of sub test cases, each of which includes a set of instructions that are organized in a particular instruction order (instruction order 1). For example, a test case may include a first sub test case and a second sub test case. The first sub test case may include five instructions that are organized in a particular instruction order, and the second sub test case may include ten instructions that are organized in a particular instruction order. During the test case build stage, test case generator 310 allocates processor resource sets to each individual sub test case, and selects instructions to insert into the sub test case based upon the resources allocated to the particular sub test case.

Micro generator 330 operates in a kernel/privilege mode, and receives test case A 105 from main generator 310. Scheduler 420 schedules the test case with the instructions in its initial instruction order 1 to dispatcher 440. In turn, dispatcher 440 dispatches the test case (instruction order 1) to processor 450.

Processor 450 executes the test case (instruction order 1) and, when finished executing the test case, processor 450 passes hardware results to results comparator 460. Results comparator 460 evaluates the results and sends a pass or fail message to scheduler 420.

When the hardware results pass, scheduler 420 passes the test case (instruction order 1) to shuffler 430. Shuffler 430 “shuffles” the instruction order of the test case to create “instruction order 2,” which results in a subsequent test case. Shuffler 430's criteria is to keep the relative instruction order within a particular sub test case the same, but other instructions from other sub test cases may be inserted between each other. In addition, shuffler 430 keeps branch instruction blocks together, or any other instruction block that needs to stay together.

Shuffler 430 provides the subsequent test case (instruction order 2) to scheduler 420. Scheduler 420 passes the subsequent test case to dispatcher 440, which dispatches the subsequent test case to processor 450.

Processor 450 executes the subsequent test case (instruction order 2) and passes hardware results to results comparator 460. Again, results comparator 460 evaluates the results and sends a pass or fail message to scheduler 420. Micro generator 330 proceeds to re-shuffle and dispatch subsequent test cases “n” times in order to sufficiently test processor 450.

FIG. 5 is a high level flowchart showing steps taken in generating a micro generator and generating test cases. A main generator, such as main generator 310 shown in FIG. 3, resides on a processor and generates a micro generator and initial test cases, which also reside on the processor.

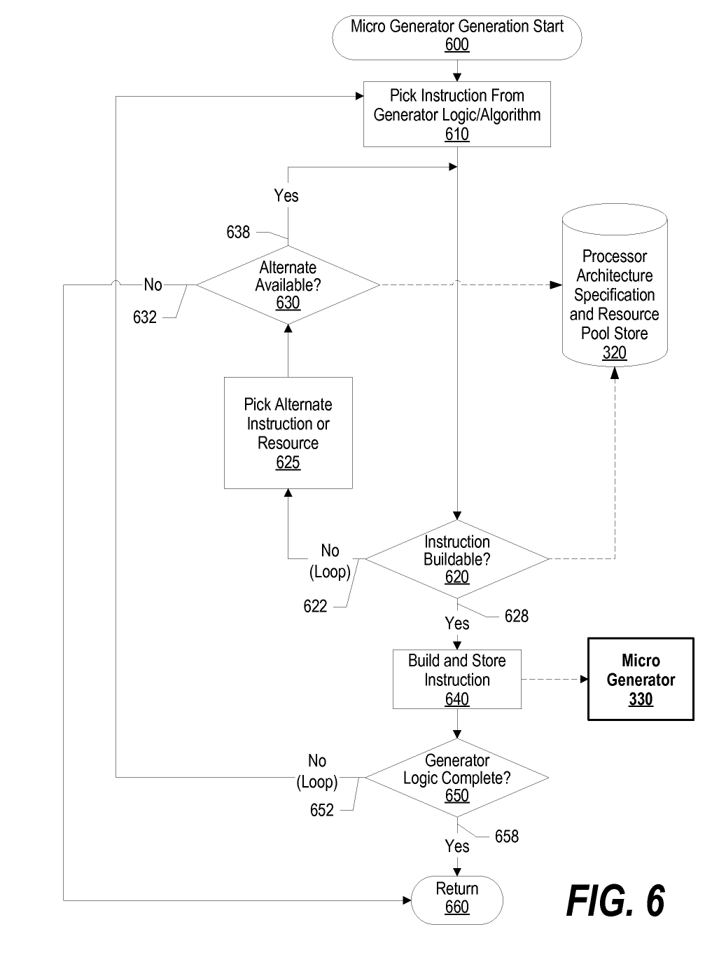

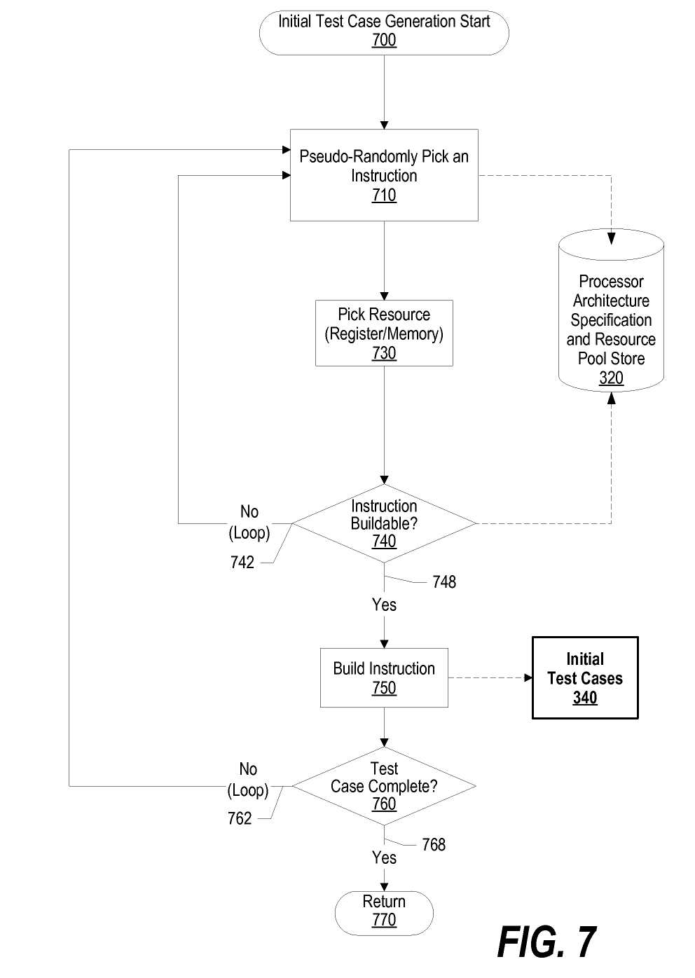

Main generator processing commences at 500, whereupon the main generator generates a micro generator using user input and a processor architecture specification included in processor architecture specification and resource pool store 320 (pre-defined process block 520, see FIG. 6 and corresponding text for further details). The processor architecture specification corresponds to the processor in which the main generator resides. In addition, the main generator generates initial test cases based upon the processor architecture specification (pre-defined process block 540, see FIG. 7 and corresponding text for further details).

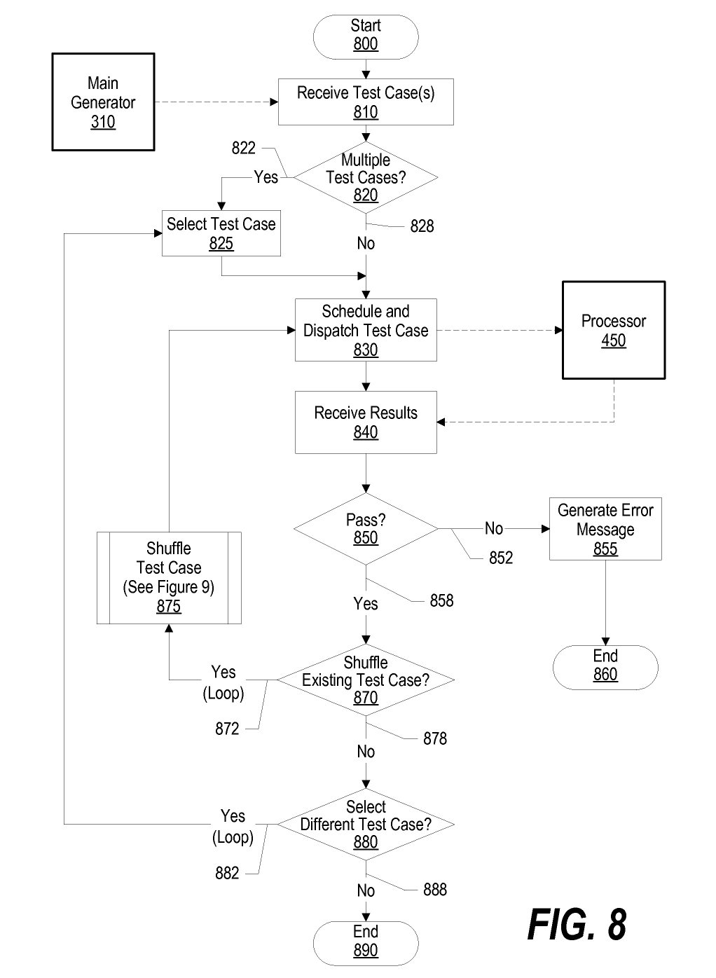

Once the micro generator and the initial test cases are created, the micro generator starts testing the processor using the initial test cases and generates subsequent test cases that may include modifying test case properties such as changing machine state register bits, changing the instruction sequence (shuffling), changing ESID and VSID bits (Effective Segment ID bits and Virtual Segment ID bits), etc. (pre-defined process block 560, see FIG. 8 and corresponding text for further details). Processing ends at 580.

FIG. 6 is a flowchart showing steps taken in a main generator generating a micro generator. Processing commences at 600, whereupon the main generator picks an instruction from a generator instruction logic/algorithm (step 610). The algorithm is used for tasks such as shuffling test cases, checking test case results, and dispatching test cases. A determination is made as to whether the instruction is buildable by comparing the instruction with a processor architecture specification included in processor architecture specification and resource pool store 320 (decision 620). For example, although the instruction may be valid, processing checks whether resources are available (enough registers, etc.) to build the instruction.

If the instruction is not buildable, decision 620 branches to “No” branch 622, which loops back to pick an alternate instruction or resource at step 625. A determination is made as to whether the picked alternate instruction or resource is available (decision 630). If the alternative instruction or resource is not available, decision 630 branches to “No” branch 632 whereupon processing returns at 660. On the other hand, if the alternate instruction or resource is available, decision 630 branches to “Yes” branch 638 whereupon a determination is made as to whether the instruction is buildable (decision 620)

If the instruction is buildable, decision 620 branches to “Yes” branch 628, whereupon processing builds and stores the instruction in micro generator 330 (step 640). A determination is made as to whether the micro generator logic/algorithm is complete (decision 650). If the micro generator logic/algorithm is not complete, decision 650 branches to “No” branch 652, which loops back pick and process the next instruction. This looping continues until the generator logic/algorithm is complete, at which point decision 650 branches to “Yes” branch 658 whereupon processing returns at 660.

FIG. 7 is a flowchart showing steps taken in a main generator generating an initial test case. Processing commences at 700, whereupon processing pseudo-randomly picks an instruction from processor architecture specification and resource pool store 320 (step 710).

At step 730, processing picks a resource (e.g., register, memory, etc.) for the instruction. A determination is made as to whether the instruction is buildable utilizing the picked resource (decision 740). For example, processing may check whether a required number of resources are available to build the instruction. If the instruction is not buildable, decision 740 branches to “No” branch 742, which loops back to pick another instruction. This looping continues until the instruction is buildable, at which point decision 740 branches to “Yes” branch 748 whereupon processing builds the instruction and stores it in initial test cases 340 (step 750).

A determination is made as to whether the test case is complete (decision 760). If the test case is not complete, decision 760 branches to “No” branch 762, which loops back to pick another instruction. This looping continues until the test case is complete, at which point decision 760 branches to “Yes” branch 768 whereupon processing returns at 770.

FIG. 8 is a flowchart showing steps taken in testing a processor using a micro generator. Processing commences at 800, whereupon processing receives one or more test cases from main generator 310 at step 810. In one embodiment, each test case includes multiple sub test cases as previously described herein.

A determination is made as to whether processing received multiple test cases (decision 820). If processing received multiple test cases, decision 820 branches to “Yes” branch 822 whereupon processing selects one of the test cases at step 825. On the other hand, if processing did not receive multiple test cases, decision 820 branches to “No” branch 828, bypassing test case selection step 825.

At step 830, processing schedules and dispatches the test case to processor 450. Processor 450 executes the test case and provides results, which are received at step 840. A determination is made as to whether the results pass (decision 850). If the results do not pass, decision 850 branches to “No” branch 852 whereupon processing generates an error message at step 855, and ends at 860.

On the other hand, if the results pass, decision 850 branches to “Yes” branch 858, whereupon a determination is made as to whether to shuffle the selected test case to create subsequent test cases (decision 870). For example, processing may shuffle the selected test case twenty times in order to provide processor 150 with twenty different test case scenarios.

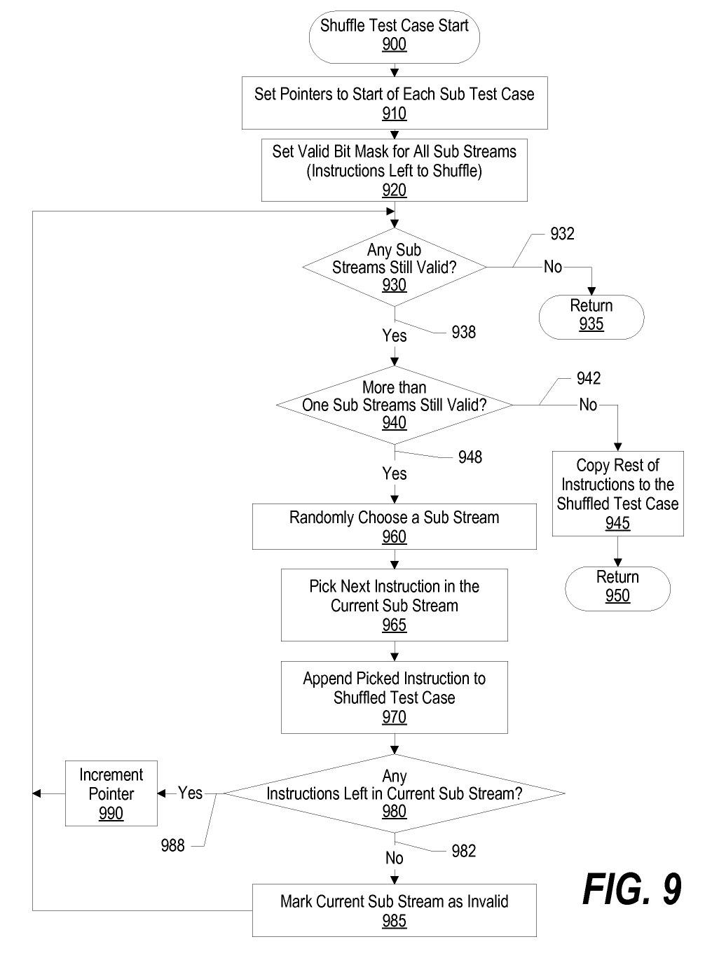

If processing should shuffle the selected test case, decision 870 branches to “Yes” branch 872, which loops back to shuffle the test case in accordance with the invention described herein (pre-defined process block 875, see FIG. 9 and corresponding text for further details). Once shuffled, processing returns to step 830 to schedule and dispatch the shuffled test case to processor 450. This looping continues until processing has finished shuffling the selected test case, at which point decision 870 branches to “No” branch 878. In one embodiment, processing may also modify other test case properties such as changing machine state register bits, changing ESID and VSID bits (Effective Segment ID bits and Virtual Segment ID bits), etc.

A determination is made as to whether to select a different test case if test case generator 310 provided multiple test cases (decision 880). If processing should select a different test case, decision 880 branches to “Yes” branch 882, which loops back to select, shuffle, and process the different test case. This looping continues until each test case has been selected and sufficiently shuffled, at which point decision 880 branches to “No” branch 888 whereupon processing ends at 890.

FIG. 9 is a flowchart showing steps taken in shuffling a test case that comprises sub test cases. Processing commences at 900, whereupon processing sets pointers to each of the sub test case's first instruction (step 910). At step 920, processing sets a valid bit mask for all sub streams (i.e. sub test cases), which are instructions within the sub test cases that are left to shuffle.

A determination is made as to whether there are any sub streams that are valid (decision 930). If there are not any sub streams that are valid, decision 930 branches to “No” branch 932 whereupon processing returns at 935. On the other hand, if there are any valid sub streams, decision 930 branches to “Yes” branch 938 whereupon a determination is made as to whether there is more than one valid sub stream still valid (decision 940). If there is not more than one valid sub stream still valid, decision 940 branches to “No” branch 942 whereupon processing copies the rest of the instructions in the valid sub stream to the shuffled test case (step 945), and returns at 950.

On the other hand, if there is more than one valid sub stream, which is typically the case at the beginning of the shuffling process, decision 940 branches to “Yes” branch 948 whereupon processing randomly selects one of the valid sub streams at step 960. At step 965, processing picks the instruction corresponding to the selected sub stream's pointer location and, at step 970, processing appends the picked instruction to the shuffled test case.

A determination is made as to whether there are any instructions left in the currently selected sub stream (decision 980). If there are not any instructions left in the selected sub stream, decision 980 branches to “No” branch 982 whereupon processing marks the selected sub stream invalid (step 985). On the other hand, if there are instructions left in the current sub stream, decision 980 branches to “Yes” branch 988 whereupon processing increments the selected sub stream's pointer at step 990, and loops back to continue to shuffle instructions. This continues until each of the instructions in each of the sub streams are appended to the test case, at which point processing returns at 950.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
selecting a plurality of instructions using a main generator, wherein each of the plurality of instructions corresponds to a processor resource specification; and
generating, from the plurality of instructions, a micro generator using the main generator, wherein the micro generator is adapted to execute a test case that tests a processor corresponding to the processor resource specification.

2. The method of claim 1 wherein the test case is an initial test case generated by the main generator, the method further comprising:
using the micro generator to generate a subsequent test case from the initial test case; and
executing the subsequent test case using the micro generator.

3. The method of claim 2 wherein the micro generator is adapted to modify one or more test case properties during the generation of the subsequent test case from the initial test case.

4. The method of claim 2 wherein the micro generator controls utilization of a plurality of processor resources included in the processor.

5. The method of claim 4 further comprising:
detecting that one of the plurality of resources is non-functional; and
in response to the detecting, re-generating the micro generator using the main generator based upon the non-functional resource.

6. The method of claim 2 wherein the micro generator includes a shuffler to generate the subsequent test case, the method further comprising:
receiving the initial test case that includes a first sub test case and a second sub test case, the first sub test case including a first set of instructions organized in a first instruction order and the second sub test case including a second set of instructions organized in a second instruction order; and
shuffling the initial test case that results in the subsequent test case, the subsequent test case including one or more of the first set of instructions inserted between one or more of the second set of instructions, wherein the first instruction order relative to the first set of instructions remains the same in the subsequent test case, and wherein the second instruction order relative to the second set of instructions remains the same in the subsequent test case.

7. The method of claim 1 wherein the main generator and the micro generator reside on the processor and the main generator utilizes the processor to generate the micro generator.

8. The method of claim 1 wherein the micro generator functions independent from an operating system or the main generator.

9. A peripheral device comprising:
one or more processors;
a memory accessible by at least one of the processors;
a nonvolatile storage area accessible by at least one of the processors;
a set of instructions stored in the memory and executed by at least one of the processors in order to perform actions of:
selecting a plurality of instructions using a main generator, wherein each of the plurality of instructions corresponds to a processor resource specification; and
generating, from the plurality of instructions, a micro generator using the main generator, wherein the micro generator is adapted to execute a test case that tests one of the processors that corresponds to the processor resource specification.

10. The peripheral device of claim 9 wherein the test case is an initial test case generated by the main generator, the set of instructions performing actions of:
using the micro generator to generate a subsequent test case from the initial test case; and
executing the subsequent test case using the micro generator.

11. The peripheral device of claim 10 wherein the micro generator is adapted to modify one or more test case properties during the generation of the subsequent test case from the initial test case.

12. The peripheral device of claim 10 wherein the micro generator controls utilization of a plurality of processor resources included in the processor.

13. The peripheral device of claim 12 wherein the set of instructions performs actions of:
detecting that one of the plurality of resources is non-functional; and
in response to the detecting, re-generating the micro generator using the main generator based upon the non-functional resource.

14. The peripheral device of claim 9 wherein the micro generator functions independent from an operating system or the main generator.

15. A computer program product stored in a computer readable medium, comprising functional descriptive material that, when executed by an information handling system, causes the information handling system to perform actions that include:
selecting a plurality of instructions using a main generator, wherein each of the plurality of instructions corresponds to a processor resource specification; and
generating, from the plurality of instructions, a micro generator using the main generator, wherein the micro generator is adapted to execute a test case that tests a processor corresponding to the processor resource specification.

16. The computer program product of claim 15 wherein the test case is an initial test case generated by the main generator, the information handling system further performing actions that include:
using the micro generator to generate a subsequent test case from the initial test case; and
executing the subsequent test case using the micro generator.

17. The computer program product of claim 16 wherein the micro generator is adapted to modify one or more test case properties during the generation of the subsequent test case from the initial test case.

18. The computer program product of claim 16 wherein the micro generator controls utilization of a plurality of processor resources included in the processor.

19. The computer program product of claim 18 wherein the information handling system further performs actions that include:
detecting that one of the plurality of resources is non-functional; and
in response to the detecting, re-generating the micro generator using the main generator based upon the non-functional resource.

20. The computer program product of claim 15 wherein the main generator and the micro generator reside on the processor and the main generator utilizes the processor to generate the micro generator.
